(19) United States
(12) Patent Application Publication
(10) Pub. No.: US 2018/0122349 A1
(43) Pub. Date: May 3, 2018

(54) SYSTEM FOR VEHICLE KARAOKE

(71) Applicants: Shane Blackburn, Lebanon, TN (US); Brian Blackburn, Lebanon, TN (US)

(72) Inventors: Shane Blackburn, Lebanon, TN (US); Brian Blackburn, Lebanon, TN (US)

(21) Appl. No.: 15/335,513

(22) Filed: Oct. 27, 2016

(51) Int. Cl. G10H 1/36

(52) U.S. Cl. CPC G10H 1/361; G10H 2230/015; G10H 2220/011; G10H 2240/121

(57) ABSTRACT

A system for engaging in karaoke within a vehicle that includes: a software application on a database; a portable electronic device adapted to assess the software application from the database; at least one headset with mic adapted to be used with the software application; a database of audio musical files accessible through the software application; and a lyric display synced with each audio music file, where the lyric display is shown on a screen of each portable electronic device engaged in the karaoke. The portable electronic device may include a smart phone or a tablet.

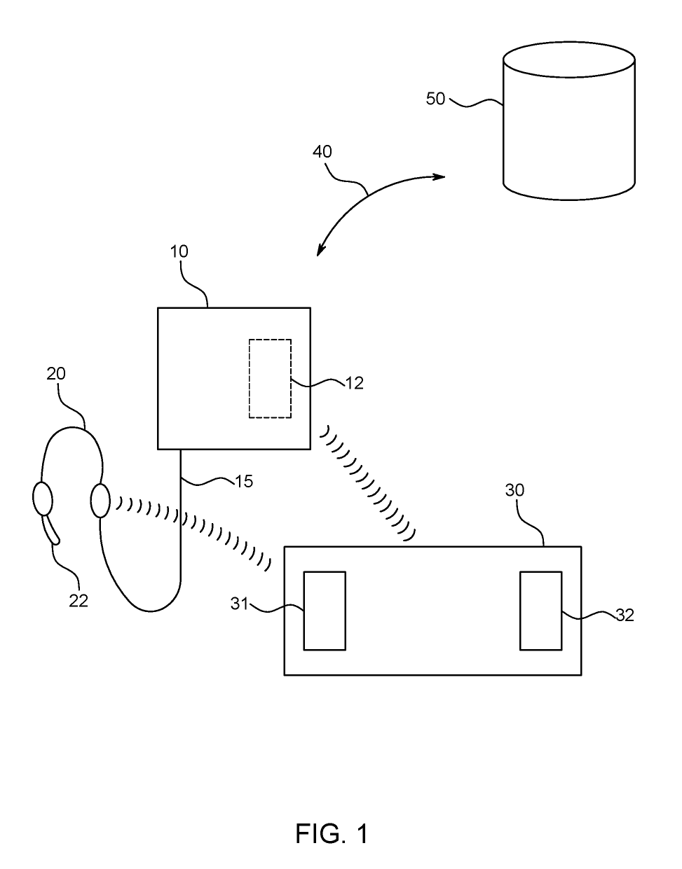

### BACKGROUND OF THE INVENTION

### Field of Invention

The present invention relates to a system to engage in karaoke within a motor vehicle.

### Description of Related Art

Karaoke is an interactive entertainment pastime that is periodically enjoyed by many individuals. Karaoke involves the playing of recorded music that is synced with lyrics which are displayed on a video screen. This system has been developed so individuals can have some enjoyable times in any almost environment. Karaoke originated in Asia but is engaged in in various locations around the world. Karaoke machines have been installed in numerous bars and other gathering places and is commonly used as an entertainment source in vacation situations such as cruises or resorts.

### SUMMARY OF THE INVENTION

The present invention relates to a system for engaging in karaoke within a vehicle that includes: a software application on a database; a portable electronic device adapted to assess the software application from the database; at least one headset with mic adapted to be used with the software application; a database of audio musical files accessible through the software application; and a lyric display synced with each audio music file, where the lyric display is shown on a screen of each portable electronic device engaged in the karaoke. The portable electronic device may include a smart phone or a tablet.

### DETAILED DESCRIPTION

The present invention relates to a software application used on a mobile electronic device. The software application engages in the interactive karaoke through the mobile electronic device. The karaoke software system includes a headset and mic that are used in conjunction with the software application. The software application is controlled through the mobile electronic device, which could be a smart phone or a tablet. Through the use of this karaoke software application a user may engage in karaoke while in a motor vehicle. The headset and mic are engaged with speakers within the motor vehicle through a Bluetooth connection. Further all music files are downloaded through the software application and played back through the mobile electronic device, which is also connected to the audio system of the vehicle through Bluetooth. The system functions as a traditional karaoke system but is integrated through the car speakers and entertainment system. Headsets may be used by each user to enjoy the karaoke experience. Lyrics are displayed on each user's electronic device as they are engaged in the karaoke game. Users may create groups and sync the lyrics within the smart phones or mobile electronic devices for each user. As a result, users may engage in a classic karaoke experience while in a motor vehicle. Such an interactive game would be highly advantageous for driving long distances which is commonly associated with singing in the vehicle.

1. A system for engaging in karaoke within a vehicle comprising:
a. a software application on a database;
b. a portable electronic device adapted to access the software application from the database;
c. at least one headset with mic adapted to be used with the software application;
d. a database of audio musical files, where the database of audio musical files resides on the portable electronic device accessible through the software application; and
e. a lyric display synced with each audio music file, where the lyric display is shown on a screen of each portable electronic device engaged in the karaoke.

2. The system for engaging in karaoke according to claim 1, wherein the portable electronic device includes a smart phone.

3. The system for engaging in karaoke according to claim 1, where the portable electronic device includes a tablet.

4. The system for engaging in karaoke according to claim 1 where groups are formed for participation in the interactive karaoke.
